(19) United States
(12) Patent Application Publication
(10) Pub. No.: US 2020/0072392 A1
(43) Pub. Date: Mar. 5, 2020

(54) CLAMP AND WORK APPARATUS HAVING SAID CLAMP

(71) Applicant: Andreas Stihl AG & Co. KG, Waiblingen (DE)

(72) Inventors: Timo Foerg, Backnang (DE); Jan Dworschak, Waiblingen (DE)

(21) Appl. No.: 16/556,002

(22) Filed: Aug. 29, 2019

(30) Foreign Application Priority Data
Aug. 30, 2018 (EP) 18191729.5

(51) Int. Cl. F16L 3/13

(52) U.S. Cl. CPC F16L 3/13

(57) ABSTRACT

A clamp for fastening an elongated element to a carrier has a first receiving region for the carrier and a second receiving region for the elongated element. The clamp has a peripheral wall defining first and second end faces. The first receiving region is delimited by a first wall section of the peripheral wall, and the second receiving region is delimited by a second wall section of the peripheral wall. The first wall section and the second wall section are mutually contiguous at two connecting locations. The first and second receiving regions between the connecting locations are mutually connected and conjointly form a single receiving space. The peripheral wall in the closed state of the clamp extends in a fully encircling manner about the receiving space. One of the wall sections has two partial wall sections and the respective ends thereof form a closure for releasably connecting the partial wall sections.

### CROSS REFERENCE TO RELATED APPLICATION

This application claims priority of European patent application no. 18 191 729.5, filed Aug. 30, 2018, the entire content of which is incorporated herein by reference.

### FIELD OF THE INVENTION

The invention relates to a clamp for fastening an elongated element or member to a carrier such as the carrier of a work apparatus. The clamp has a first receiving region for the carrier and a second receiving region for the elongated member. The clamp has a first end face and a second end face with a peripheral wall extending therebetween. The first receiving region is delimited by a first wall section of the peripheral wall and the second receiving region is delimited by a second wall section of the peripheral wall. The first wall section and the second wall section are mutually contiguous at two connecting locations. The first receiving region and the second receiving region are connected to one another between the connecting locations and conjointly form a single receiving space.

### BACKGROUND OF THE INVENTION

Plastic clamps having a single receiving space are known for fastening elongated elements such as cables, lines, or hoses, to a carrier of a work apparatus, for example to the guide tube of a string trimmer. The guide tube as well as the cable are disposed in the receiving space. In order for the cable to be fastened to the guide tube, the clamp by being spread apart at an interruption can be simultaneously placed over the guide tube and the cable. After the termination of the spreading apart, the elastic clamp springs back to the original state thereof. It has been demonstrated that clamps of this type can easily be unintentionally pulled from the guide tube.

### SUMMARY OF THE INVENTION

It is an object of the invention to provide a clamp to ensure a reliable fastening of an elongated element to a carrier.

This object can, for example, be achieved by a clamp for fastening an elongated member to a carrier. The clamp defines a closed state and an open state and includes: a peripheral wall defining a first receiving region for accommodating the carrier and a second receiving region accommodating the elongated member; the peripheral wall defining a first end face and a second end face; the peripheral wall having a first wall section delimiting the first receiving region and a second wall section delimiting the second receiving region; the first wall section and the second wall section being mutually contiguous at a first connecting location and at a second connecting location; the first receiving region and the second receiving region being mutually connected between the first and second connecting locations and conjointly defining a single receiving space; the peripheral wall extending completely about the single receiving space when the clamp is in the closed state; and, one of the first and second wall sections including first and second partial wall sections having respective first and second ends conjointly defining a closure for releasably connecting the first and second partial wall sections.

A further object of the invention lies in refining a work apparatus in such a manner that the elongated element or member of the work apparatus is reliably fastened to the carrier of the work apparatus.

In the case of the clamp according to the invention it is provided that the peripheral wall in the closed state of the clamp extends in a fully encircling manner about the receiving space, and that one of the two wall sections of the peripheral wall has two partial sections, the ends thereof forming a closure for releasably connecting the partial wall sections. The clamp can be reliably closed by way of the closure. A spreading apart of the partial wall sections is precluded in the closed state of the clamp on account of the closure. The expansion forces are determined by the configuration and the positioning of the closure and not solely by the spring force of the partial wall sections. On account thereof, the clamp can remain in the closed state even under the effect of high expansion forces. In an opened state of the clamp, a spreading apart of the clamp is counteracted only by the spring force of the partial wall sections and of the wall section that connects the partial wall sections. On account of not only the spring force determining the expansion force in the closed state, the wall sections of the clamps can be configured in a more elastic manner. On account thereof, the clamp can be more easily spread apart and placed onto the elongated element and the carrier. On account of the single receiving space being delimited by the one peripheral wall, the one wall section can be utilized as a type of articulation for the partial wall sections of the other wall section that are moved counter to one another. This can likewise lead to the clamp being more easily spread apart.

On account of the two receiving regions forming a single receiving region, the peripheral wall can be configured so as to be comparatively long. Also on account thereof, a high elasticity of the peripheral wall can be achieved, the high elasticity enabling the clamp to advantageously be able to be opened so far that the clamp can be push-fitted onto the carrier or else onto the carrier and the elongated element in the direction that is radial to the carrier.

In comparison to clamps which have a permanently closed first receiving space for the guide tube of a string trimmer, and a second spreadable receiving space for a throttle cable, the second receiving space being configured separately from the first receiving space, the clamp according to the invention has the advantage that the carrier does not have to be pushed through the receiving space in order for the clamp be fastened to the carrier. Assembling and dismantling the clamp is also possible when further items are fastened to the carrier. In the case of a second receiving space that is configured so as to be separate from the first receiving space, the forces for pulling the clamp from the guide tube are limited by the spring force of the spreadable legs of the second receiving space. On account of the first and the second receiving forming a common receiving space according to the invention, this limitation is dispensed with in the case of a clamp according to the invention.

The first receiving region and the second receiving region between the connecting locations of the wall sections are advantageously connected to one another by way of a constricted location of the receiving space. On account thereof, the shape of one receiving region can be adapted to the shape of the carrier be received therein and/or of the elongated element to be received therein. This results in defined positions of the carrier and of the elongated element in the clamp.

The clamp possesses a width, measured at the constricted location of the receiving space in a plane parallel to the front end between the connecting locations of the wall sections. The second receiving region possesses a second maximum diameter, measured parallel to the width. The second maximum diameter of the second receiving region is advantageously at least as large as the width between the connecting locations of the wall sections. The second maximum diameter of the second receiving space is in particular larger than the width of the receiving space between the connecting locations. On account thereof, the elongated element can be held in a form-fitting manner in the clamp. On account thereof, the elongated element cannot be lost when the clamp is released from the carrier. The assembly of the clamp on the carrier can be simplified on account thereof, since the operator while assembling the clamp on the carrier does not have to do hold the elongated element in position in the clamp.

The first receiving region possesses a first maximum diameter, measured parallel to the width of the receiving space. In an advantageous embodiment of the invention, the first maximum diameter of the first receiving region is larger than the second maximum diameter of the second receiving region. On account thereof, the first maximum diameter of the first receiving region can be adapted to the diameter of the carrier, for example, and the second maximum diameter of the second receiving region can be adapted to the diameter of the elongated element, for example. On account thereof, the first wall section of the first receiving region can bear on the carrier, for example. On account thereof, the second wall section of the second receiving region can likewise bear on an elongated element. A reliable mounting of the carrier and of the elongated element in the clamp is guaranteed on account thereof.

The closure is expediently disposed in the region of the first wall section. In the case of a comparatively large diameter of the first receiving region, this results in a larger length of the first wall section, this leading to an increased elasticity of the first wall section. On account of the disposal of the closure in the region of the first wall section, the closure can be configured such that the closure can be easily opened and closed.

The clamp is advantageously integrally configured. On account thereof, the clamp is easy to produce and stable. In an alternative embodiment, a disposal in the region of the second wall section can also be provided.

The clamp is advantageously at least partially made from plastics material. On account thereof, the clamp can be produced in a simple manner. A desired elasticity and strength of the clamp can be achieved in a simple manner on account of the configuration of the clamp made from plastics material.

The closure is expediently a snap-fit connection having a male hook-shaped element and a female element. On account thereof, the closure can be produced in a simple manner. Separate components are advantageously not required for the production of the closure. The clamp can in particular be configured such that the snap-fit connection can be easily opened and closed by the operator, in particular using one hand or a screwdriver, such that an easy operation results. The male element and the female element advantageously interact in the closed state. On account thereof, the clamp is securely closed in the closed state. On account thereof, the carrier and the elongated element can be securely held in the clamp.

The first end of the first partial wall section advantageously has a rib. The second end of the second partial wall section advantageously has a groove. In an advantageous embodiment of the invention, the rib in the closed state of the clamp engages in the groove such that a movement of the first end of the first partial wall section of the clamp in relation to the second end of the second partial wall section of the clamp in the direction from the one front end to the other front end is delimited. On account thereof, twisting of the clamp and unintentional opening of the clamp in the closed state can be prevented. Likewise, unintentional opening of the clamp by displacing the ends of the wall section in relation to one another in the direction from the one front end to the other front end can be prevented. A secure mounting of the elongated element on the carrier by the clamp is possible on account thereof.

The groove advantageously comprises a first groove wall and a second groove wall for receiving therebetween the rib. The first groove wall and the second groove wall in a view in the direction perpendicular to the front end are expendiently mutually disposed without an overlap. On account thereof, the groove walls can be produced free of undercuts in a casting method, in particular an injection-molding method. The clamp thus molded can be readily demolded without casting cores being required.

The clamp in the closed state between the first end of the first partial wall section and the second end of the second partial wall section advantageously has a gap. In an advantageous embodiment of the invention, the clamp has a support element which in the closed state bridges the gap at at least one location in the peripheral direction of the peripheral wall. On account thereof, the closure of the clamp can be securely closed. The support element can prevent any twisting of the clamp and any unintentional release of the closure.

In an advantageous embodiment of the invention, the clamp has a device for modifying a length of the clamp in the peripheral direction of the peripheral wall. On account thereof, the clamp can be configured such that the closure of the clamp can be released and closed in a simple manner.

The clamp on the inner periphery of the first receiving region expediently has at least two contact regions for bearing on the carrier. The clamp possesses a center axis which extends in the direction from the one front end to the other front end. The contact regions at least in the closed state of the clamp advantageously have a first distance from the center axis, the first distance being smaller than a second distance of a spring section from the center axis. The spring section in the peripheral direction of the peripheral wall is advantageously disposed between the contact regions on the inner periphery of the first receiving region. On account thereof, the closure can be opened and closed in a simple manner. To this end, the spring section can be moved in the direction toward the center axis. A wrapping angle of the clamp about the peripheral direction, measured in the peripheral direction of the peripheral wall, is enlarged herein. On account thereof, the male hook-shaped element and the female element can be removed from one another and the closure can thus be opened. On account of the disposal of the contact regions and of the spring section in the first receiving region, the spring section can have a large length in the peripheral direction and in this way be particularly elastic. Comfortable opening of the closure of the clamp is possible on account thereof.

The contact regions are advantageously configured by elevations on the peripheral wall of the clamp. The elevations in relation to the peripheral wall expediently project in the direction from the inner periphery of the first receiving region toward the center axis. On account thereof, the contact regions can be produced in a simple manner.

It is advantageously provided that the clamp in the closed state possesses a region having a third distance from an imaginary circle, wherein the center of the imaginary circle lies on the center axis and the imaginary circle bears on the clamp, and that the third spacing from the circle is capable of being reduced for opening the clamp.

In an advantageous embodiment of the invention, the clamp has a fixation rib for engaging between ribs of the elongated element and for fixing the elongated element in relation to a movement in the direction from one front end to the other front end. The fixation rib is expediently disposed on the inner periphery of the second receiving region and in relation to the inner periphery projects in the direction from the inner periphery of the second receiving region toward the center axis of the clamp. The center axis of the clamp extends in the direction from the first front end of the clamp to the second front end of the clamp and in the closed state is completely enclosed by the peripheral wall of the clamp. On account of the fixation rib, the clamp in relation to the elongated element can be secured in a simple manner against displacements in the direction of the center axis.

The work apparatus according to the invention comprises a carrier and an elongated element. The invention provides that the elongated element is fastened to the carrier by a clamp according to the invention. On account thereof, the elongated element is securely held on the carrier.

In an advantageous embodiment of the work apparatus it is provided that the clamp in the closed state bears on the carrier, that the clamp possesses a region having a third distance from the carrier, and that the third distance from the carrier is capable of being reduced for opening the clamp.

### BRIEF DESCRIPTION OF THE DRAWINGS

The invention will now be described with reference to the drawings wherein:

FIG. 1 shows a schematic view of a work apparatus;

FIG. 2 shows a schematic lateral view of the work apparatus from FIG. 1;

FIG. 3 shows a perspective view of a carrier and a clamp disposed thereon, in the open state;

FIG. 4 shows a perspective view of an elongated element and the carrier and the clamp from FIG. 3, in the closed state;

FIG. 5 shows a perspective illustration of the elongated element and the clamp from FIG. 3, in the open state;

FIG. 6 shows a lateral view of the clamp, the carrier, and the elongated element from FIG. 4, viewed in the direction of the arrow VI in FIG. 4;

FIG. 7 shows a lateral view of the clamp from FIG. 4, viewed in the direction of the arrow VII in FIG. 4;

FIGS. 8 to 10 show perspective illustrations of the clamp from FIG. 3, in the open state;

FIGS. 11 and 12 show perspective illustrations of the clamp from FIG. 4, in the closed state;

FIG. 13 shows an enlarged illustration of a detail of the clamp from FIG. 6;

FIG. 14 shows a section through the clamp from FIG. 3 along the section line XIV-XIV in FIG. 7;

FIGS. 15 and 16 show perspective illustrations of an alternative embodiment of a clamp, in the open state;

FIG. 17 shows a schematic illustration of a carrier and an alternative embodiment of a clamp having a device for modifying the length of the clamp in the peripheral direction of a peripheral wall of the clamp; and,

FIGS. 18 to 20 show schematic lateral views in the direction of a longitudinal center axis of the various embodiments of clamps having contact regions and spring sections.

### DESCRIPTION OF THE PREFERRED EMBODIMENTS OF THE INVENTION

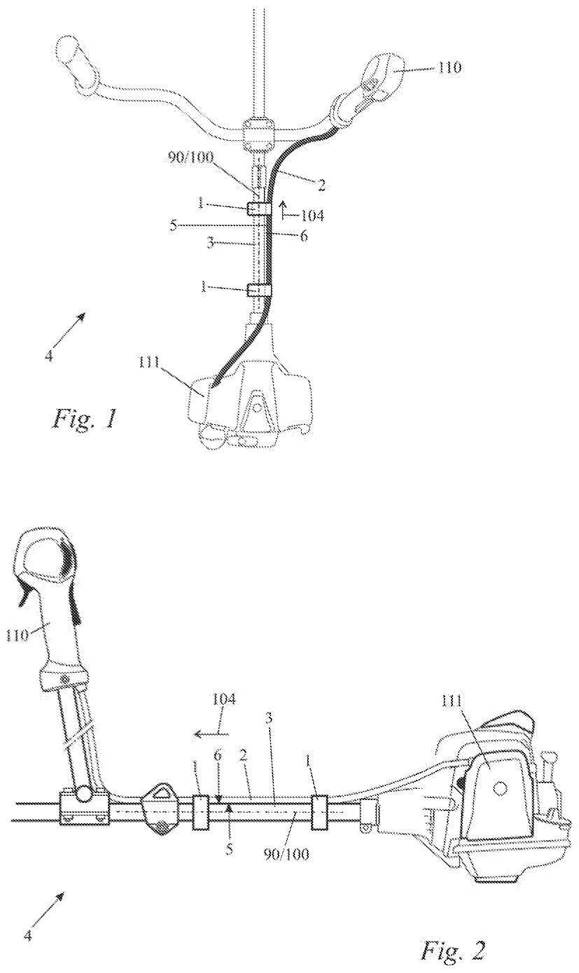

FIGS. 1 and 2 show a work apparatus 4 having a carrier 3 to which an elongated element 2 is fastened by a clamp 1. In the embodiments, the work apparatus 4 is a brushcutter, the carrier 3 thereof being configured as a guide tube for guiding the work apparatus. The elongated element 2 is a tubular element in which a throttle cable is guided. The elongated element 2 runs between a handle 110 of the work apparatus 4 and a motor housing 111 of the work apparatus 4. The handle 110 and the motor housing 111 are disposed at a mutual distance on the carrier 3. Between the handle 110 and the motor housing 111 the elongated element 2 is fastened to the carrier 3 of the work apparatus 4 by two clamps 1. The elongated element 2 configured as a tubular element is guided along the carrier 3 configured as a guide tube. This enables comfortable working with the work apparatus 4, wherein any entangling in the elongated element 2 is prevented. In this way, the risk of the elongated element 2 catching on a branch, for example, when working with the work apparatus 4 is also reduced.

The clamp 1 can also be used in other work apparatus such as, for example, a spray apparatus. In the case of a spray apparatus, the elongated element can be a hose for guiding a liquid or pulverulent spray agent, and the carrier can be a blower tube of the spray apparatus. Likewise, an elongated element configured as a throttle cable can be fastened to the carrier, configured as a blower tube of a blower apparatus, by the clamp 1.

The elongated element 2 possesses a longitudinal direction 104. The carrier 3 possesses a longitudinal axis 90. The longitudinal axis 90 of the carrier 3 and the longitudinal direction 104 of the elongated element 2 run so as to be parallel in the region of the clamp 1. The elongated element 2 has a longitudinal side 5. The carrier 3 has a longitudinal side 6. The elongated element 2 and the carrier 3 by way of the respective longitudinal sides 5, 6 thereof are disposed beside one another in the clamp 1. The clamp 1 has a center axis 100. In the case of the elongated element 2 being fastened to the carrier 3 by the clamp 1, the center axis 100 runs through the clamp 1 so as to be parallel to the longitudinal axis 90 of the carrier 3.

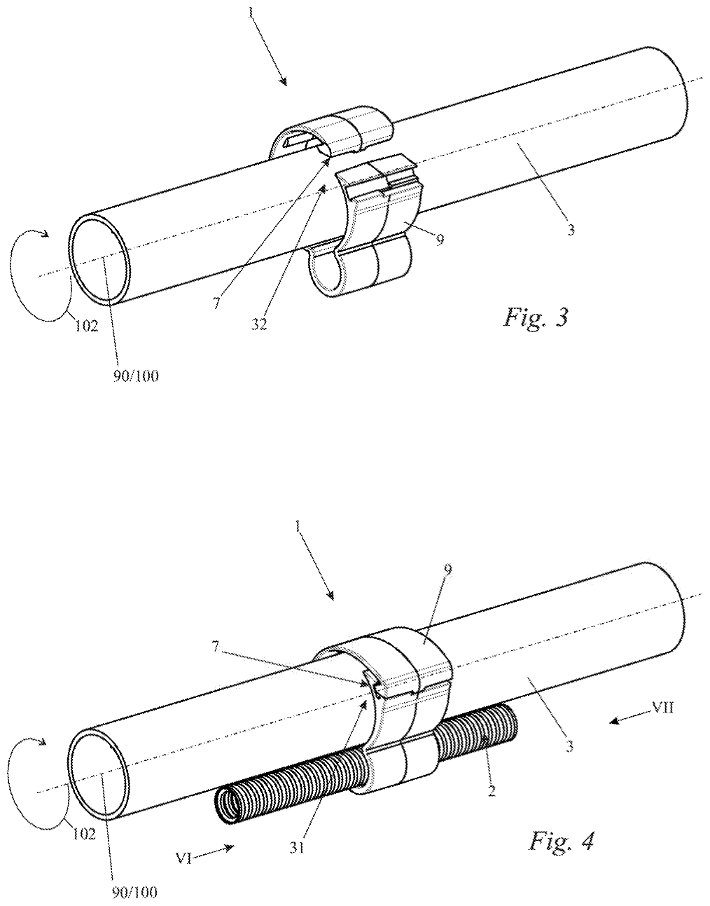

FIG. 3 shows the carrier 3 and the clamp 1, disposed on the carrier 3, in the open state 32. The clamp 1 at least partially encompasses the longitudinal axis 90 of the carrier 3. The clamp 1 has a closure 7. The closure 7 is opened in the open state 32 shown in FIG. 3. The clamp 1 has a peripheral wall 9. The peripheral wall 9 extends about the carrier 3 in a peripheral direction 102. The peripheral direction 102 runs about the center axis 100. The peripheral wall 9 in the open state 32 of the clamp 1 does not run completely but only partially about the center axis 100 in the peripheral direction 102. In the open state 32 the peripheral wall 9 has an interruption in the peripheral direction 102. On account of the interruption, the clamp 1 in the open state 32 can be pulled off or pushed onto the carrier 3 in the direction transversely to the longitudinal axis 90 of the latter. The clamp 1 herein is elastically deformed and temporarily widened.

FIG. 4 shows the carrier 3, the elongated element 2, and the clamp 1 in a closed state 31. The elongated element 2 is fastened to the carrier 3 by the clamp 1. The closure 7 is closed in the closed state 31 of the clamp 1. In the closed state 31, the peripheral wall 9 of the clamp 1 in the peripheral direction 102 runs completely about the center axis 100 of the clamp 1. The clamp 1 in the closed state 31 completely encompasses the center axis 100 of the clamp 1 and encloses the center axis 100 by way of a peripheral angle of 360°. The longitudinal axis 90 of the carrier 3 and the center axis 100 of the clamp 1 coincide in FIG. 4.

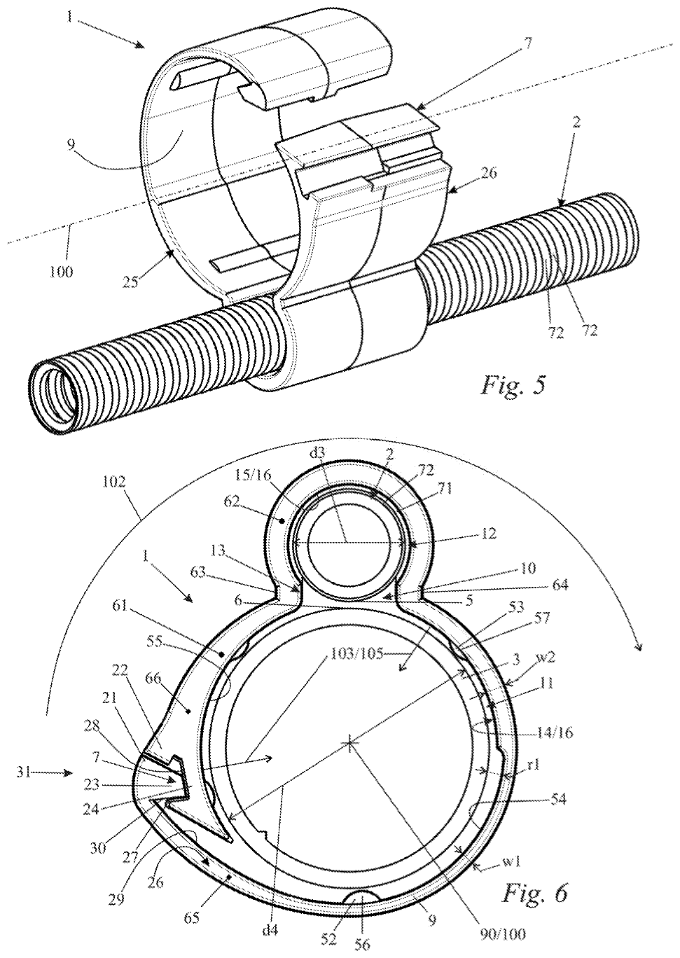

As is illustrated in FIG. 5, the clamp 1 has a first front end 25 and a second front end 26. The first front end 25 and the second front end 26 in the embodiment extend, respectively, so as to be orthogonal to the center axis 100 of the clamp 1. However, another profile of the front ends can also be advantageous. The front ends 25 and 26 delimit clamp 1 in the direction of the center axis 100. The peripheral wall 9 extends between the first front end 25 and the second front end 26.

FIG. 6 shows a view of the assembly from FIG. 4 in the direction of the center axis 100. The clamp 1 fastens the elongated element 2 to the carrier 3. The clamp 1 is in the closed state 31. When the elongated element 2 is fastened to the carrier 3 by the clamp 1, the center axis 100 of the clamp 1 runs through a receiving space 10 of the clamp 1 so as to be parallel to the longitudinal axis 90 of the carrier 3. The center axis 100 coincides in particular with the longitudinal axis 90. The clamp 1 has a first receiving region 11 for the carrier 3. The clamp 1 has a second receiving region 12 for the elongated element 2. The first receiving region 11 and the second receiving region 12 conjointly form the single receiving space 10. The first receiving region 11 is delimited by a first wall section 61 of the peripheral wall 9. The second receiving region 12 is delimited by a second wall section 62 of the peripheral wall 9. The first wall section 61 and the second wall section 62 are mutually contiguous at two connecting locations 63, 64. The first wall section 61 is connected to the second wall section 62 at the connecting locations 63 and 64. The first receiving region 11 and the second receiving region 12 in the region between the connecting locations 63 and 64 are connected to one another so as to form the single receiving space 10. In the closed state 31 of the clamp 1 illustrated in FIG. 6, the peripheral wall 9 extends so as to fully encircle the receiving space 10.

The first receiving region 11 has an inner periphery 14. The second receiving region 12 has an inner periphery 15. The inner periphery 14 of the first receiving region 11 and the inner periphery 15 of the second receiving region 12 conjointly form an inner periphery 16 of the single receiving space 10. The shape of the inner periphery 14 of the first receiving region 11 for bearing on the carrier 3 is configured so as to be substantially concave in the embodiment. The shape of the inner periphery 15 of the second receiving region 12 for bearing on the elongated element 2 is configured so as to be concave. Other shapes of the inner periphery of the first receiving region and of the inner periphery of the second receiving region can also be advantageous.

One of the two wall sections 61 and 62 has two partial wall sections 65 and 66. In the embodiments, the first wall section 61 has the first partial wall section 65 and the second partial wall section 66. The first partial wall section 65 has a first end 21.

The partial wall section 66 has a second end 22. The ends 21 and 22 are simultaneously ends of the peripheral wall 9. The ends 21 and 22 form the closure 7 for releasably connecting the partial wall sections 65 and 66. In the embodiments, the closure 7 is disposed in the region of the first wall section 61. The clamp 1 has only one single closure 7. In the closed state 31, the clamp 1, that is closed by the closure 7, encloses the center axis 100 without any interruption. The clamp 1 can be brought to the open state illustrated in FIGS. 3 and 5 by opening the closure 7.

As is illustrated in FIG. 6, the closure 7 is a snap-fit connection. The closure 7 comprises a male hook-shaped element 23 and the female element 24. The male element 23 and the female element 24 interact in the closed state 31 of the clamp 1. The male element 23 in the closed state 31 is hooked into the female element 24. The closure 7 in the closed state 31 of the clamp 1 connects the first partial wall section 65 and the second partial wall section 66 to one another in a form-fitting manner. The female element 24 has a depression 28. The depression 28 in relation to a projection 27 of the female element 24 is depressed in the direction 105 from the inner periphery 14 of the first receiving region 11 toward the center axis 100 of the clamp 1. The projection 27 delimits the depression 28 in the direction counter to the peripheral direction 102. The peripheral direction 102, proceeding from the second end 22 of the first wall section 61, runs about the center axis 100 in the direction away from the first end 21 of the first wall section 61 toward the second wall section 62. The projection 27 holds the male element 23 and prevents any movement of the first end 21 in the direction toward the open position of the first end 21 of the first wall section 61, the open position being assumed by the first end 21 in the open state 32 of the clamp 1.

The first wall section 61 has an inner side 29. The inner side 29 faces the center axis 100. In the region of the first end 21, the hook-shaped element 23 in relation to the inner side 29 of the first wall section 61 projects in the direction 105 from the inner periphery 14 of the first receiving region 11 in the region of the hook-shaped element 23 in the direction toward the center axis 100. The shape of the male hook-shaped element 23 corresponds to the shape of the depression 28 and the shape of the projection 27 of the female element 24. The hook-shaped element 23 counter to the peripheral direction 102 is delimited by a flank 30. In the closed state 31 of the clamp 1, the flank 30 of the hook-shaped element 23 bears on the projection 27 in the depression 28 of the female element 24. In the closed state 31 of the clamp 1, the flank 30 of the hook-shaped element 23 pushes against the projection 27 of the female element 24.

The clamp 1 is integrally configured. The second partial wall section 66 of the first wall section 61 is connected to the second wall section 62 at the first connecting location 63. The second wall section 62 is connected to the first partial wall section 65 of the first wall section 61 at the second connecting location 64. In the closed state 31, the first partial wall section 65 of the first wall section 61 is connected to the second partial wall section 66 of the first wall section 61 by way of the closure 7.

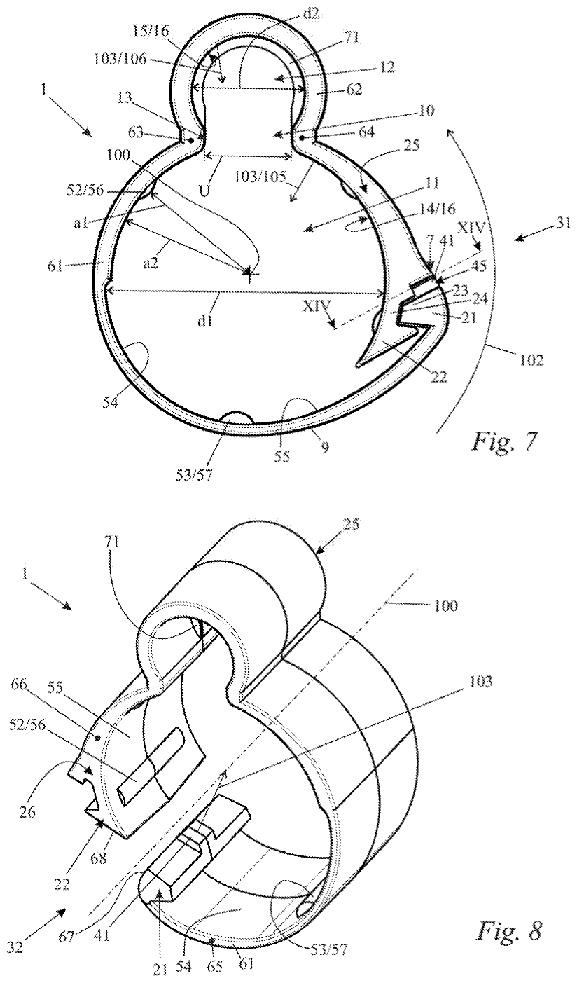

FIG. 7 shows the clamp 1 in the closed state 31, without an elongate element disposed in the clamp 1 and without a carrier. The first receiving region 11 and the second receiving region 12, between the first connecting location 63 and the second connecting location 64, are connected to one another by way of a constricted location 13 of the single receiving space 10. The clamp 1 possesses a width U, measured at the constricted location 13 of the receiving space 10 in a plane parallel to the front end 25 between the first connecting location 63 and the second connecting location 64. The second receiving region 12 possesses a second maximum diameter d2, measured parallel to the width U. The second maximum diameter d2 is at least as large as the width U. It can be provided that the second maximum diameter is exactly as large as the width of the receiving space at the constricted location. In the embodiments, the second maximum diameter d2 is larger than the width U. The width U is advantageously smaller than an outer diameter d3, illustrated in FIG. 6, of an elongated element 2 that is disposed in the clamp 1. On account thereof, the elongated element 2 can be clipped into the second receiving region 12 and in terms of the position of the elongate element 2 is fixed in the second receiving region 12.

As is illustrated in FIG. 7, the first receiving region 11 possesses a first maximum diameter d1, measured parallel to the width U of the receiving space 10 at the constricted location 13. The first maximum diameter d1 of the first receiving region 11 is larger than the second maximum diameter d2 of the second receiving region 12. It can also be provided that the second maximum diameter of the second receiving region is larger than the first maximum diameter of the first receiving region. The first receiving region 11 is provided for receiving the carrier 3. The second receiving region 12 is provided for receiving the elongated element 2. The second maximum diameter d2 of the second receiving region 12 is at least as large as, preferably larger than, the outer diameter d4, illustrated in FIG. 6, of the carrier 3.

As is illustrated in FIG. 7, the clamp 1 has a fixation rib 71. The fixation rib 71 is provided for engaging between neighboring ribs 72 of the elongated element 2, illustrated in FIG. 5. When the elongated element 2 is clamped in the clamp 1, the ribs 72 in the region of the clamp 1 are disposed beside one another in the direction of the center axis 100. The ribs 72 project in the radial direction of the elongated element 2, thus perpendicularly to the center axis 100. The fixation rib 71 is configured such that the fixation rib 71 engages between the ribs 72 of the elongated element 2 in such a manner that the elongated element 2 is fixed in relation to a movement in the direction from one front end 25, 26 to the other front end 25, 26. The fixation rib 71 is disposed on the inner periphery 15 of the second receiving region 12, as is illustrated in FIG. 7. The fixation rib 71 in relation to the inner periphery 15 projects in the direction 103 from the inner periphery 15 toward the center axis 100 of the clamp 1. The center axis 100 runs perpendicularly to the front ends 25 and 26 of the clamp 1. As is illustrated in FIG. 8, the fixation rib 71 in the direction of the center axis 100 is disposed in the center of the clamp 1, between the first front end 25 and the second front end 26.

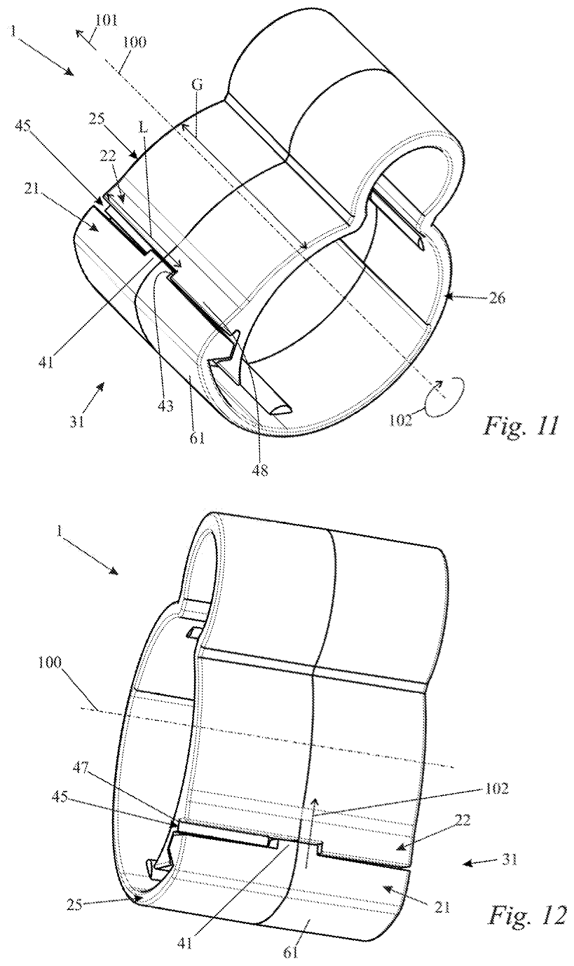

FIGS. 8 to 12 show various perspective views of the clamp 1 in the open state 32 and in the closed state 31. The first end 21 of the first wall section 61 has a rib 41. The second end 22 of the first wall section 61 has a groove 42. The rib 41 and the groove 42 extend in the peripheral direction 102 and at least by way of a vectoral proportion in the radial direction 103 toward the center axis 100. In the closed state 31 of the clamp 1, illustrated in FIGS. 11 and 12, the rib 41 engages in the groove 42 according to the tongue-and-groove principle. The rib 41 can also be referred to as a spring. The rib 41 in the closed state 31 of the clamp 1 engages in the groove 42 such that a movement of the first end 21 of the first wall section 61 of the clamp 1 in relation to the second end 22 of the first wall section 61 of the clamp 1, in the direction from the one front end 25, 26 to the other front end 25, 26, is delimited.

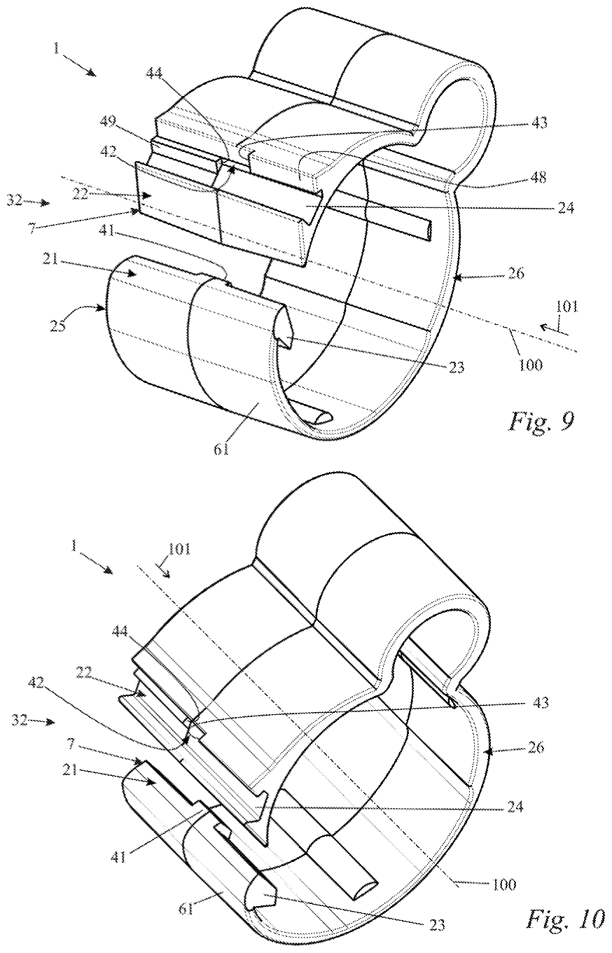

As is illustrated in FIGS. 9 and 10, the groove 42 has a first groove wall 43 and a second groove wall 44 for receiving the rib 41 therebetween. The first groove wall 43 is part of a first web 48. The second groove wall 44 is part of a second web 49. The groove walls 43 and 44 run transversely, in particular perpendicularly, to the center axis 100. The first web 48 and thus also the first groove wall 43 are assigned to the second front end 26. The second web 49 and thus also the second groove wall 44 are assigned to the first front end 25. The first web 48 and the second web 49 extend in the direction of the center axis 100. The first web 48 and the second web 49 are mutually spaced apart in the direction of the center axis 100. The center axis 100 extends in an axis direction 101. The axis direction 101 runs parallel to the center axis 100, in the direction from the second front end 26 toward the first front end 25, as is plotted in FIG. 9.

As is illustrated in FIGS. 11 and 12, the clamp 1 in the closed state 31, between the first end 21 and the second end 22, has a gap 45. The gap 45, as is illustrated in FIG. 11, extends in the axis direction 101 from the first groove wall 43 to the first front end 25. In a view of the clamp 1 in the axis direction 101, the first web 48 obscures the gap 45. In the closed state 31 of the clamp 1, the gap 45 represents a depression in the outer periphery of the clamp 1. The gap 45 has a length L, measured in the axis direction 101. The length L of the gap 45 in the embodiment is more than 50% of a total length G of the clamp 1, measured in the axis direction 101. It can also be provided that the length of the gap is less than 50%. It can in particular be provided that the length of the gap is 0% of the total length.

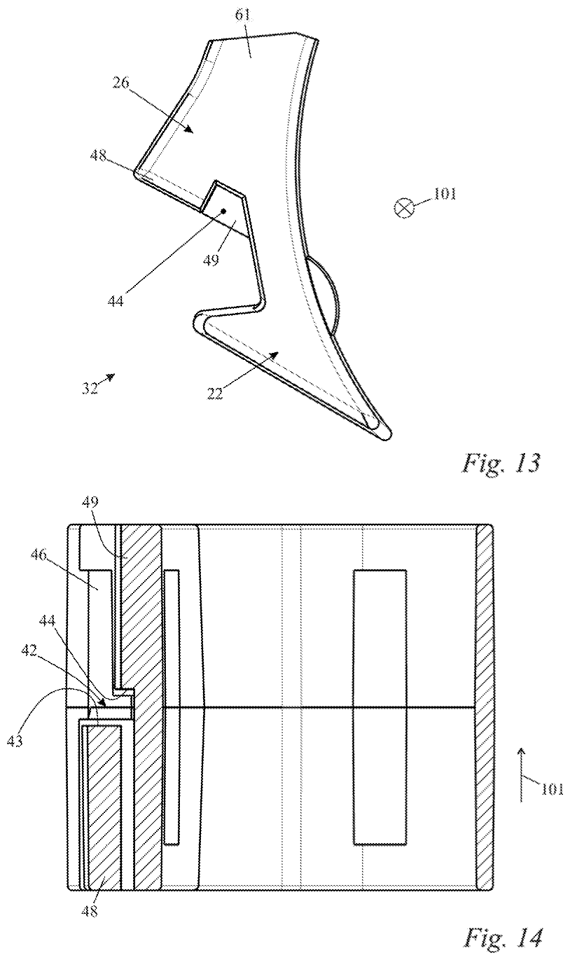

FIG. 13 shows a view in the axis direction 101, perpendicular onto the second front end 26, toward the second end 22 of the first wall section 61 in the open state 32 of the clamp 1. The first groove wall 43 is not visible in this view illustrated in FIG. 13. The first groove wall 43 is disposed on that end of the first web 48 that faces away from the second front end 46. The first groove wall 43 and the second groove wall 44, in a view in the direction perpendicular to the second front end 26, thus in the axis direction 101, are mutually disposed without an overlap.

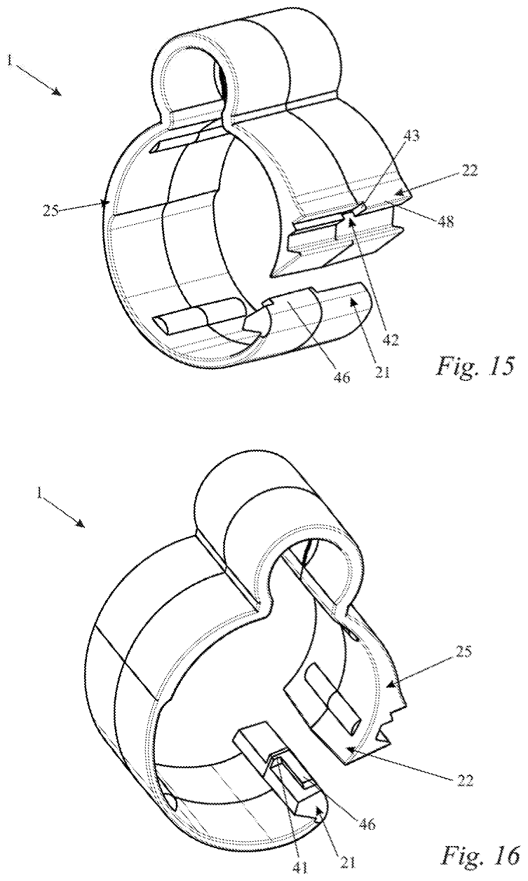

This is also derived from the sectional illustration shown in FIG. 14. FIG. 14 shows a section through an alternative embodiment of the clamp 1 illustrated in FIGS. 15 and 16. The embodiment as per FIGS. 15 and 16 has a support element 46. In the illustrations as per FIGS. 3 to 12, the clamp 1 does not have any such support element. The position of the section plane of the section through the clamp 1 according to the variant of embodiment as per FIGS. 15 and 16 is plotted in the case of a clamp 1 without a support element in FIG. 7. It can be clearly seen in FIG. 14 that the first groove wall 43 and the second groove wall 44, in a view in the axis direction 101, are mutually disposed without an overlap. In the view in the axis direction 101, the first web 48 and the second web 49 are also mutually disposed without an overlap. In the closed state 31 of the clamp, the rib 41 in the axis direction 101 lies between the first groove wall 43 and the second groove wall 44. The rib 41 and the groove 42 extend in a plane perpendicular to the axis direction 101. In the closed state 31 of the clamp 1, the first groove wall 43 and the second groove wall 44 delimit a relative movement between the first end 21 of the first wall section 61 and the second end 22 of the first wall section 61 in the direction perpendicular to the front ends 25 and 26.

The clamp 1 is at least partially made from plastics material. On account of the disposal of the groove walls 43 and 44 without an overlap in the view in the axis direction 101, easy demolding of the clamp 1 which is at least partially produced from plastics material in an injection-molding method is possible.

FIGS. 15 and 16 show an alternative embodiment of the clamp 1 which additionally comprises the support element 46. It is derived from FIGS. 11, 15, and 16 that the support element 46 in the closed state 31 bridges the gap 45, shown in the context of the first embodiment in FIGS. 11 and 12, at at least one location in the peripheral direction 102 of the peripheral wall 9. It can be provided that the support element completely fills the gap in the closed state of the clamp. In the embodiment as per FIGS. 15 and 16, the support element 46 in the closed state 31 of the clamp 1 bridges the gap 45 at least across 70% of the length of extent of the gap 45. The rib 41 is advantageously disposed on the support element 46, as is shown in particular in FIG. 16.

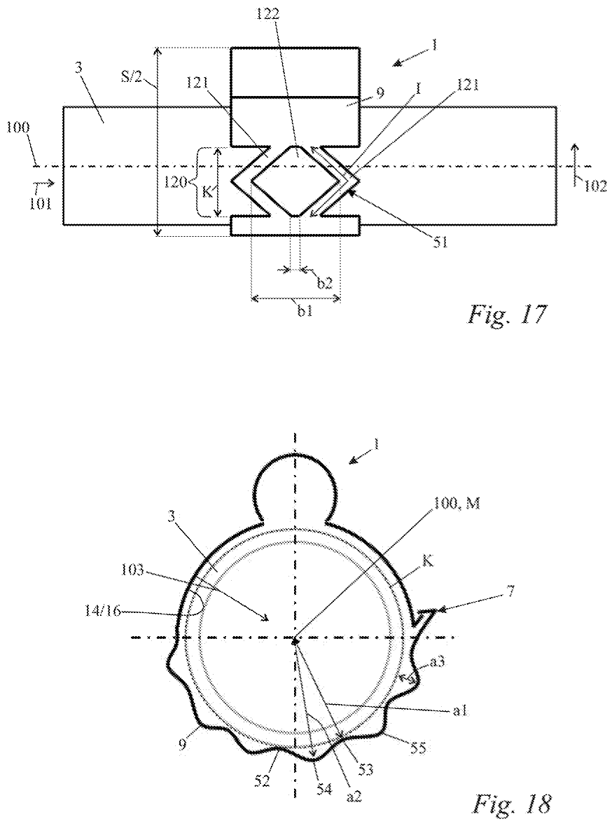

FIG. 17 shows a further variant of embodiment of the clamp 1. The clamp 1 as per FIG. 17 has a device 51 for modifying an absolute length S of the clamp 1, the length S being measured along the profile of the clamp 1 in a plane perpendicular to the center axis 100. The length S represents a path integral of the profile of a projection of the clamp 1 in the axis direction 101 onto the plane perpendicular to the center axis 100. The clamp 1 is elastically deformable. The peripheral wall 9 has a peripheral section 120. The peripheral wall 9 in the peripheral section 120 is composed of two webs 121. The length I of a web 121 along the profile thereof is longer than the length K of the peripheral section 120, the length K being measured in the peripheral direction 102. The length I represents a path integral along the profile of the web 121. The two webs 121 delimit a through opening 122 in the peripheral wall 9. The opening 122, in the center of the peripheral section 120 in terms of the peripheral direction 102, has a width b1 measured in the axis direction 101. The opening 122, in the peripheral direction closer to the rim of the peripheral section 120 has a width b2, measured in the axis direction 101. The width b1 in the center of the peripheral section 120 is larger than the width b2 at the rim of the peripheral section 120. The integrated length S of the clamp 1 along the profile of the latter perpendicular to the center axis 100 can be enlarged by compressing the webs 121 in the direction of the center axis 100. The width b1 of the opening 122 in the center of the peripheral section 120 is decreased herein. The length K of the peripheral section 120 in the peripheral direction 102 is likewise enlarged. On account of the device 51 for modifying the length S of the clamp 1 in the peripheral direction 102, the male hook-shaped element 23, illustrated in FIG. 6, can be released from the female element 24 in a simple manner. On account of the enlargement of the length S of the clamp 1 in the peripheral direction 102, the flank 30 of the hook-shaped element 23 can be removed from the projection 27 of the female element 24 in the peripheral direction 102 in a simple manner. The flank 30 in this instance is no longer pushed against the projection 27, and the hook-shaped element 23 can be released from the female element 24.

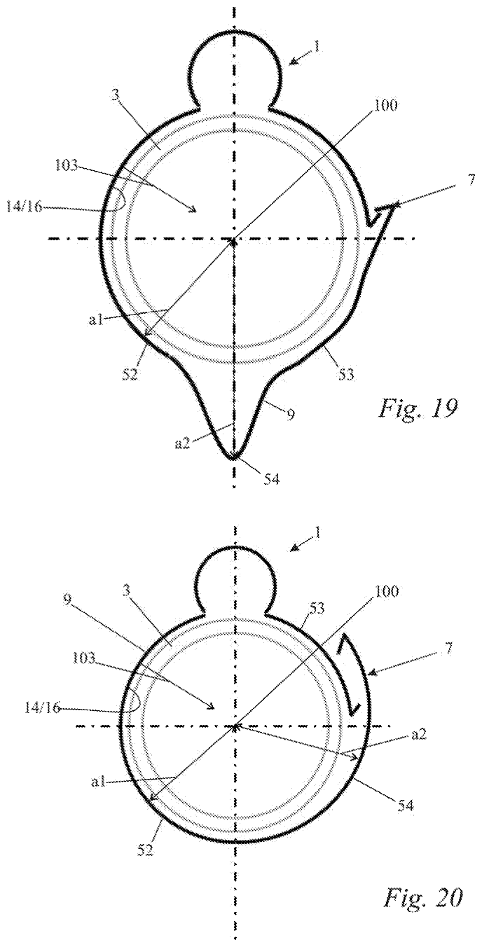

FIGS. 18 to 20 show further various embodiments of the clamp 1 having various mechanisms for releasing the closure 7 of the clamp 1. The clamp 1 is elastically deformable for releasing the closure 7. The clamp 1 on the inner periphery 14 of the first receiving region 11 has at least two contact regions 52, 53 for bearing on the carrier 3. At least one spring section 54 is disposed in the peripheral direction 102 of the peripheral wall 9 between the contact regions 52 and 53. In the embodiment as per FIG. 18, one spring section 54, 55 is in each case provided between two neighboring contact regions 52 and 53. A plurality of contact regions 52, 53 are provided as per FIG. 18. The contact regions 52 and 53 at least in the closed state 31 of the clamp 1 have a first distance a1 from the center axis 100. The spring section 54, 55 at least in the closed state 31 of the clamp 1 has a second distance a2 from the center axis 100. The first distance a1 of the contact regions 52 and 53 from the center axis 100 is less than the second distance a2 of the spring section 54, 55 from the center axis 100.

The clamp 1 according to the embodiment as per FIGS. 3 to 16 and 18 to 20 in the closed state 31 of the clamp 1 wraps the carrier 3 along a first wrapping angle. The first wrapping angle is larger than 360°. The elastic peripheral wall 9 of the clamp 1 in the closed state 31 of the clamp 1 in the region of the spring section 54, 55 (FIGS. 6, 7, 18, 19, and 20) can be pushed inward in the direction toward the center axis 100. The wrapping angle is enlarged on account thereof. The length of the clamp 1 along the profile thereof in a plane perpendicular to the center axis 100 remains constant. The clamp 1 the pushed-in the state of the peripheral wall 9 wraps the carrier 3 along a second wrapping angle. The second wrapping angle is larger than the first wrapping angle. On account of the second wrapping angle being larger than the first wrapping angle, the closure 7 can be opened by pushing in the spring section 54, 55. When pushing-in the spring section 54, 55, the male hook-shaped element 23, illustrated in FIG. 6, is removed from the female element 24 in a manner as analogous to that of the embodiment as per FIG. 17, and the closure 7 is thus opened.

In the embodiment as per FIG. 6, the contact regions 52 and 53 are configured by elevations 56 and 57 on the peripheral wall 9 of the clamp 1. The elevations 56 and 57 in relation to the peripheral wall 6 project in the direction 105 from the inner periphery 14 of the first receiving region 11 toward the center axis 100. In the closed state 31 of the clamp 1, the elevations 56 and 57 bear on the carrier 3. The spring section 54 is disposed in the peripheral direction 102 between the elevation 56 and the elevation 57. As has already been described in the context of the embodiments as per FIGS. 18 to 20, the spring section 54 in the closed state 31 of the clamp 1 has a larger distance a2 from the center axis 100 than the elevations 56 and 57.

The first wall portion 61 has at least one partial wall section 65 having a wall thickness w1 reduced at least in sections. The first wall section 61 in the region of the partial wall section 65 having reduced wall thickness w1 possesses a larger radial distance r1 from the carrier 3 than in regions having a non-reduced wall thickness w2. By virtue of the reduced wall thickness w1 and of the larger radial distance r1 from the carrier 3, the partial wall section 65 having a reduced wall thickness w1 can be pushed radially inward in the direction 103, on account of which the closure 7 can be unhooked.

It is common to all embodiments as per FIGS. 3 to 16 and 18 to 20, that the clamp 1 in the closed state 31 has a region having a third distance a3 from an imaginary circle K, wherein the center M of the imaginary circle K lies on the center axis 100 and the imaginary circle K bears on the clamp 1, and that the third distance a3 from the circle K is capable of being reduced for opening the clamp 1. This is illustrated in manner in FIG. 18. FIG. 18 also shows the carrier 3, the outer periphery of the latter coinciding with the imaginary circle K. The imaginary circle K is plotted with dashed lines. The clamp 1 in the closed state 31 bears on the carrier 3. Accordingly, the third distance a3 exists between the clamp 1 and the imaginary circle K as well as between the clamp 1 and the carrier 3. The third distance a3 from the carrier 3 is capable of being reduced for opening the clamp 1. The spacing a3 is measured in the radial direction of the circle K.

On account of the reduced wall thickness of the partial wall section 65, the latter can also be sufficiently spread apart from the other partial wall section 66 so that the carrier 3 can be pushed-in in a radial manner. In order for the pushing-in of the carrier 3 to be facilitated, lead-in chamfers 67 and 68, illustrated in FIG. 8, are provided on the partial wall sections 65 and 66. The lead-in chamfers 67 and 68 cause the clamp 1 to be further spread upon contact with the carrier 3 when push-fitting the clamp 1 onto the carrier 3 in the direction perpendicular to the center axis 100.

It is understood that the foregoing description is that of the preferred embodiments of the invention and that various changes and modifications may be made thereto without departing from the spirit and scope of the invention as defined in the appended claims.

What is claimed is:

1. A clamp for fastening an elongated member to a carrier, said clamp defining a closed state and an open state and comprising:
a peripheral wall defining a first receiving region for accommodating said carrier and a second receiving region accommodating said elongated member;
said peripheral wall defining a first end face and a second end face;
said peripheral wall having a first wall section delimiting said first receiving region and a second wall section delimiting said second receiving region;
said first wall section and said second wall section being mutually contiguous at a first connecting location and at a second connecting location;
said first receiving region and said second receiving region being mutually connected between said first and second connecting locations and conjointly defining a single receiving space;
said peripheral wall extending completely about said single receiving space when said clamp is in said closed state; and,
one of said first and second wall sections including first and second partial wall sections having respective first and second ends conjointly defining a closure for releasably connecting said first and second partial wall sections.

2. The clamp of claim 1, wherein said first receiving region and said second receiving region are mutually connected via a constriction location of said receiving space between said first and second connecting locations.

3. The clamp of claim 2, wherein:
said claim has a width (U) measured at said constriction location of said receiving space in a plane parallel to said end faces between said connecting locations of said first and second wall sections;
said second receiving region has a second largest diameter (d2) measured parallel to said width (U); and,
said second largest diameter (d2) is at least as large as said width (U).

4. The clamp of claim 3, wherein:
said first receiving region has a first largest diameter (d1) measured parallel to said width (U); and,
said first largest diameter (d1) is greater than said second largest diameter (d2).

5. The clamp of claim 1, wherein said closure is disposed in the region of said first wall section.

6. The clamp of claim 1, wherein said clamp is integrally configured.

7. The clamp of claim 1, wherein said clamp is made at least in part of plastic.

8. The clamp of claim 1, wherein said closure is a snap-fit connection having a male hook-shaped element and a female element; and, said male element and said female element intersect in said closed state.

9. The clamp of claim 1, wherein said first end of said first partial wall section has a rib; and, said second end of said second partial wall section has a groove for receiving said rib therein when said clamp is in said closed state with said rib engaging in said groove so as to limit a movement of said first end relative to said second end in a direction from one of said end faces to the other one of said end faces.

10. The clamp of claim 9, wherein:
said groove has first and second groove walls for receiving said rib therebetween; and,
said first groove wall and said second groove wall are without mutual overlapment in a view taken in a direction perpendicular to said end faces.

11. The clamp of claim 1, wherein:
in the closed state of said clamp, said first end of said first partial wall section and said second end of said second partial wall section conjointly define a gap; and,
the clamp further comprises a support element configured to bridge said gap at least at one location in the peripheral direction of said peripheral wall in said closed state of said clamp.

12. The clamp of claim 1, further comprising a device for clamping a length (S) of said clamp in the peripheral direction of said peripheral wall.

13. The clamp of claim 1, wherein:
said clamp defines a center axis extending from one of said end faces to the other one of said end faces;
said peripheral wall has an inner periphery delimiting said first receiving region;
said clamp further comprises contact regions at said inner periphery for bearing on said carrier as well as spring sections;
said contact regions are at a first distance (a1) from said center axis and said spring sections are at a second distance (a2) from said center axis;
said first distance is less than said second distance (a2); and,
said spring sections in the peripheral direction of the peripheral wall are disposed between said contact regions on said inner periphery of said first receiving region.

14. The clamp of claim 13, wherein the contact regions are configured by elevations on said peripheral wall of said clamp;
and, said elevations in relation to said peripheral wall project in the direction from said inner periphery of said first receiving region toward said center axis.

15. The clamp of claim 1, wherein:
said clamp defines a center axis;
said clamp, in the closed state thereof, has a region having a third distance (a3) from an imaginary circle (K);
said imaginary circle (K) has a center (M) on said center axis and said imaginary circle lies on said clamp; and,
said third spacing (a3) to said circle is reducible for opening said clamp.

16. The clamp of claim 1, wherein:
said clamp defines a center axis;
said clamp has a fixation rib for engaging between ribs of said elongated member and for fixing said elongated member in relation to a movement in the direction from one of said end faces to the other one of said end faces; and,
said fixation rib is disposed on the inner periphery of said second receiving region and, in relation to the inner periphery, projects in a direction from the inner periphery of said second receiving region toward said center axis of said clamp that extends from said one end face to said other end face of the clamp.

17. A work apparatus comprising:
a carrier;
an elongated member; and, a clamp for fastening said elongated member to said carrier;
said clamp defining a closed state and an open state and including:
a peripheral wall defining a first receiving region for accommodating said carrier and a second receiving region accommodating said elongated member;
said peripheral wall defining a first end face and a second end face;
said peripheral wall having a first wall section delimiting said first receiving region and a second wall section delimiting said second receiving region;
said first wall section and said second wall section being mutually contiguous at a first connecting location and at a second connecting location;
said first receiving region and said second receiving region being mutually connected between said first and second connecting locations and conjointly defining a single receiving space;
said peripheral wall extending completely about said single receiving space when said clamp is in said closed state; and,
one of said first and second wall sections including first and second partial wall sections having respective first and second ends conjointly defining a closure for releasably connecting said first and second partial wall sections.

18. The work apparatus of claim 17, wherein:
said clamp, in the closed state, bears on said carrier;
said clamp defines a region at a third distance (a3) from said carrier; and,
said third distance (a3) from said carrier is reducible for opening said clamp.
